(19) United States
(12) Patent Application Publication
(10) Pub. No.: US 2004/0046778 A1
(43) Pub. Date: Mar. 11, 2004

(54) System and method to transcode and playback digital versatile disc (DVD) content and other related applications

(76) Inventors: Sithampara Babu Niranjan, Larkspur, CA (US); John Carney, Corte Madera, CA (US); David De Andrade, San Anselmo, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/358,494

(22) Filed: Feb. 4, 2003

Related U.S. Application Data
(60) Provisional application No. 60/409,402, filed on Sep. 9, 2002.

(51) Int. Cl. G09G 5/00

(52) U.S. Cl. 345/716

(57) ABSTRACT

A system and method to transcode and playback DVD content and other related applications are described. Content information is received from a content source in a source format. Supplemental data is further received in a predetermined format from multiple servers. The content information is subsequently processed using the supplemental data in order to transform the content information from the source format to a predetermined format. The processed content information is then transmitted to a server for further processing and playback to a client coupled to the server.

### RELATED APPLICATION

The present application is related to and claims the propriety benefit of U.S Provisional Patent application No. 60/409,402, filed Sep. 9, 2002.

### FIELD OF THE INVENTION

The present invention relates generally to content distribution in a network environment and, more particularly, to a system and method to transcode and playback Digital Versatile Disc (DVD) content and other related applications.

### BACKGROUND

Recently, there has been an explosion in the number of DVD players shipped and in the amount of DVD content and the number of applications published. Nevertheless, DVD authoring remains an expensive activity.

At the same time, millions of digital Set-Top Boxes (STB) and Personal Video Recorder (PVR) class devices are being deployed all over the world. However, the majority of these devices do not have the capabilities to decode and play DVD content and applications. Thus, there is a need for a system to transcode the available DVD content and applications appropriately, such that the content and respective applications may be played back on devices having no native DVD playback capabilities.

### SUMMARY

A system and method to transcode and playback DVD content and other related applications are described. Content information is received from a content source in a source format. Supplemental data is further received in a predetermined format from multiple servers. The content information is subsequently processed using the supplemental data in order to transform the content information from the source format to a predetermined format. The processed content information is then transmitted to a server for further processing and playback to a client coupled to the server.

In one embodiment, content derived from a DVD source is transmitted for playing through a client device that is not equipped with a DVD decoder. The content includes rich media assets and associated data, each in a transcoded format other than as originally provided from the DVD source. The associated data includes presentation information and metadata concerning the rich media assets, and in one example, the transcoded format comprises an extensible markup language format, but more generally may be selected according to various transcoding rules.

In a further embodiment, an application program is developed from DVD content other than rich media assets for execution by a device not equipped with a DVD decoder. The application program, when executed by the device, provides one or more interactive menus for controlling playback of a transcoded version of the rich media assets via the device. The application program may be developed using transcoded presentation information and metadata concerning the rich media assets and the presentation information may be transcoded according to various transcoding rules.

Other features and advantages of the present invention will be apparent from the accompanying drawings and from the detailed description, which follows below.

### BRIEF DESCRIPTION OF THE DRAWINGS

The present invention is illustrated by way of example and not intended to be limited by the figures of the accompanying drawings in which like references indicate similar elements and in which:

FIG. 1 is a block diagram of one embodiment of a communications network environment in which embodiments of the present invention can be implemented;

FIG. 2A is a block diagram of one embodiment of a content provider within the communications network environment.

FIG. 2B is a block diagram of one embodiment of a server within the communications network environment;

FIG. 2C is a block diagram of one embodiment of a transcoding process.

FIG. 3 is a block diagram of one embodiment of a client within the communications network environment;

FIG. 4 is a flow diagram of one embodiment of a method to transcode content information within the content provider;

FIG. 5A is a flow diagram of one embodiment of a method to receive and process the transcoded content information within the server for transmission to one or more clients;

FIG. 5B is a flow diagram of one embodiment of a method to transmit video and/or audio content to the clients;

FIG. 6 is a flow diagram of one embodiment of a method to receive and display the video and/or audio content for an end user;

FIG. 7 is a block diagram of one embodiment of a machine in the exemplary form of a computer system within which a set of instructions may be executed.

### DETAILED DESCRIPTION

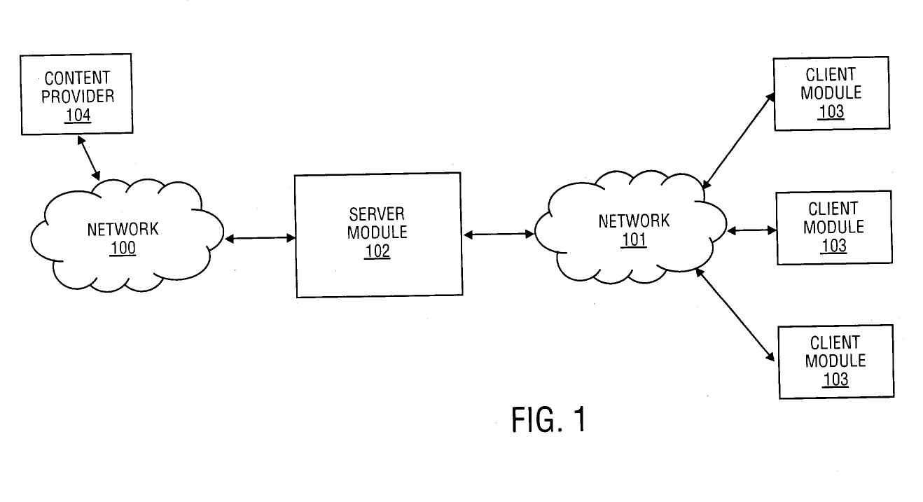

According to embodiments described herein, a system and method to transcode and playback DVD content and other related applications are described. In the following detailed description of embodiments of the invention, reference is made to the accompanying drawings in which like references indicate similar elements, and in which are shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the claims. p FIG. 1 is a block diagram of one embodiment of a communications network environment in which embodiments of the present invention can be implemented. As illustrated in FIG. 1, one or more servers, of which server 102 is shown, and one or more clients 103 are coupled to each other via network 101, through terrestrial based wireless communication links or, alternatively, through space based communication links. Server 102 and clients 103 maybe coupled to the terrestrial based links in the network 101 through one or more antennas (not shown). Alternatively, server 102 and clients 103 may be coupled to the space based links in the network 101 through one or more dish antennas (not shown). The terrestrial based communication links may be, for example, television broadcast links. The space based communication links may be, for example, satellite broadcast links. Communication network 101 may be implemented in any one of a number of interactive environments.

Clients 103 may include, but are not limited to, for example, a set top box, a receiver, a television set, a game platform, a personal video recorder (PVR), or other receiving devices. In addition, one or more applications may be running on the clients 103. For purposes of explanation, a single server 102 and a single client 103 will be considered to illustrate one embodiment of the present invention. It will be readily apparent that the present invention may be easily applied to multiple servers 102 and/or multiple clients 103.

The network 101 may be a Wide Area Network (WAN), which includes the Internet, or other proprietary networks used to transmit data streams between server 102 and any number of clients 103. In another embodiment, the network 101 may be a broadcast network, which transmits a video signal and other data from server 102 to clients 103. Alternatively, the network 101 may include a Local Area Network (LAN), a satellite link, a wireless network, a fiber network, a Hybrid Fiber Coax (HFC) or cable network, or any combination of the above. Network 101 may also include network backbones, long-haul telephone lines, and various levels of network routers.

In one embodiment, the server 102 is coupled to one or more content providers, of which content provider 104 is shown in FIG. 1, via a network 100, which maybe the same or similar to the network 101. Server 102 and content provider 104 may be coupled to each other through terrestrial based wireless communication links or, alternatively, through space based communication links. Server 102 and content provider 104 may be coupled to the terrestrial based links in the network 100 through one or more antennas (not shown). Alternatively, server 102 and content provider 104 may be coupled to the space based links in the network 100 through one or more dish antennas (not shown). The terrestrial based communication links may be, for example, television broadcast links. The space based communication links may be, for example, satellite broadcast links. Communication network 100 may also be implemented in any one of a number of interactive environments. In an alternate embodiment, the server 102 and the content provider 104 may be connected through a direct link, such as, for example, through the mail system or by physically transporting content from the content provider 104 to the server module 102.

In one embodiment, the network 100 may be a Wide Area Network (WAN), which includes the Internet, or other proprietary networks used to transmit data streams between content provider 104 and server 102. In another embodiment, the network 100 may be a broadcast network, which transmits a video signal and other data from content provider 104 to server 102. Alternatively, the network 100 may include a Local Area Network (LAN), a satellite link, a wireless network, a fiber network, a cable network, or any combination of the above. Network 100 may also include network backbones, long-haul telephone lines, and various levels of network routers.

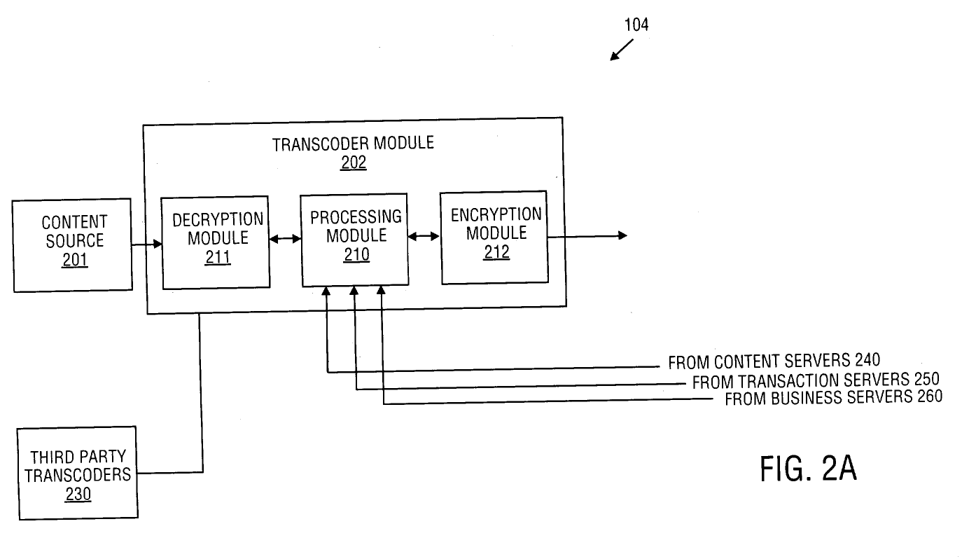

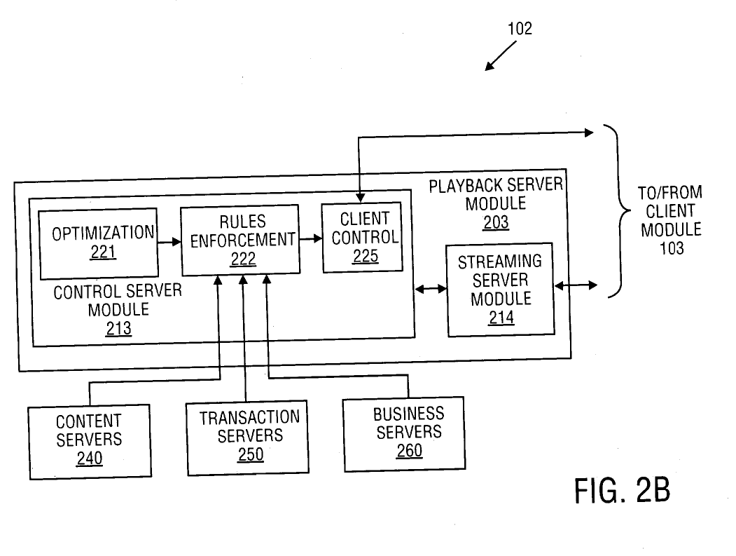

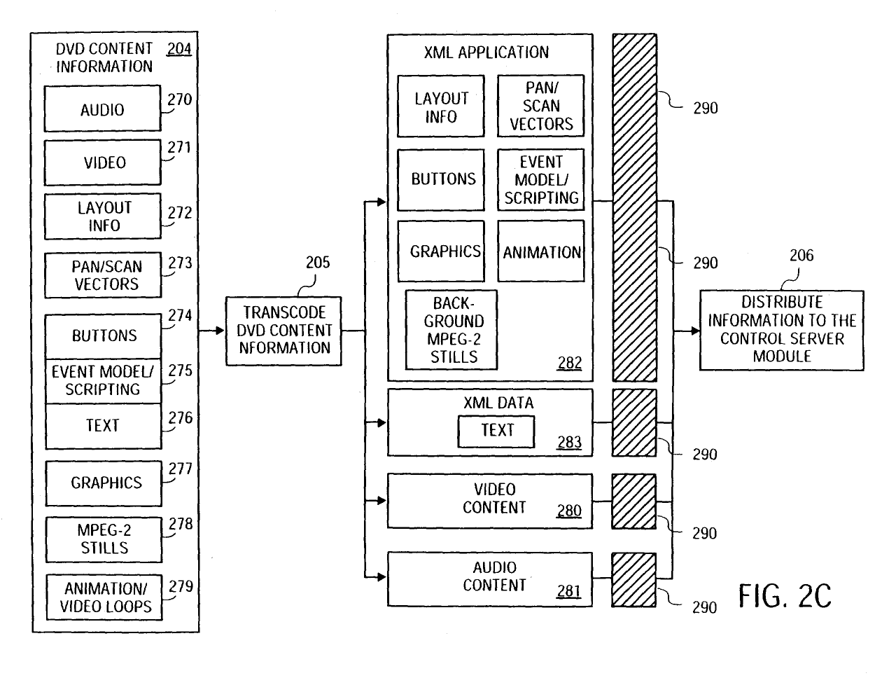

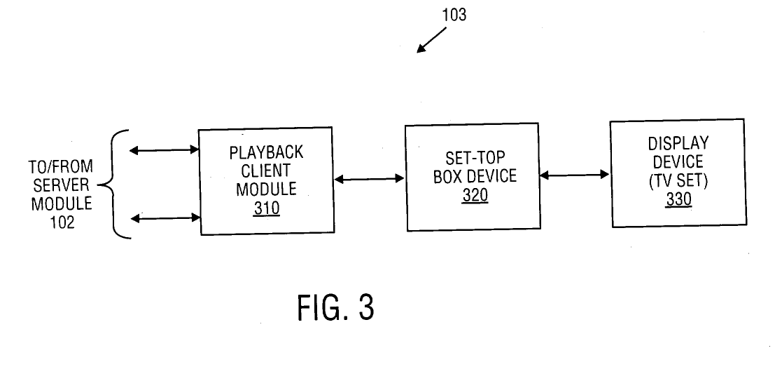

In an alternate embodiment, networks 100 and 101 may be collapsed into one common network that connects content provider 104, server 102, and clients 103. In yet another alternate embodiment, content provider 104 may be contained within the server 102. In yet another alternate embodiment, content provider 104 may include specific components of the server 102. The content provider 104, server 102, and client 103 will be described in further detail below in connection with FIGS. 2A, 2B, and 3, respectively.

FIG. 2A is a block diagram of one embodiment of a content provider within the communications network environment. As illustrated in FIG. 2A, content provider 104 includes a content source 201, such as, for example, a Digital Versatile Disc (DVD) based content source. The content source 201 outputs content information in a source format, such as, for example, DVD content, which includes rich media assets (e.g., video content, audio content), and associated data, such as presentation information (e.g., layout information, subpicture overlays, MPEG-2 I-frame stills, alternate camera angles, navigation/interactivity information, scripting information, graphics), asset metadata (e.g., parental control rating levels, regional codings, pan/scan vectors), and other available information (e.g., text), as described in further detail below in connection with FIG. 2C.

In one embodiment, content provider 104 further includes a transcoder module 202 coupled to the content source 201 and may also include other components, such as, for example, third party transcoders 230. The transcoder module 202 is a programmable hardware and/or software module to perform transcoding operations as described herein. In the detailed description that follows, “transcoding operations” refer to transformations of the DVD content information from the source format supported by the content source 201 to a predetermined format supported by the client 103, such as, for example the eXtensible Markup Language (XML) format.

The transcoder module 202 may be a programmable software module executed by a processor within the content provider 104 to perform operations such as, for example, decryption, transcoding, and encryption of content information, and other supplemental information, such as business rules, and/or transaction information, as described in further detail below. Alternatively, the transcoder module 202 may be programmable hardware such as a field programmable gate array (FPGA) device that is programmed to perform the same operations.

In one embodiment, the transcoder module 202 further includes a decryption module 211 coupled to the content source 201 to receive and decrypt content information received from the content source 201. In addition, the transcoder module 202 includes a processing module 210 coupled to the decryption module 211 to receive decrypted content information from the decryption module 211 and to transcode the content information into a predetermined format according to specific rules, as described in further detail below. Furthermore, the transcoder module 202 includes an encryption module 212 coupled to the processing module 210 to receive and encrypt the transcoded content information for subsequent transmission to the server 102.

In an alternate embodiment, the decryption module 211 and encryption module 212 are optional and the processing module 210 is the sole module contained within the transcoder module 202. As a result, the respective decryption and encryption operations may be performed in a separate module within the content provider 104 or may not be performed at all.

In one embodiment, the processing module 210 is coupled to one or more content servers 240, to one or more transaction servers 250, and/or to one or more business servers 260 located within the server 102. The processing module 210 receives business rules from the business servers 260 and transaction information from the transaction servers 250 in a predetermined format, such as, for example, the eXtensible Markup Language (XML) format, and selectively attaches applicable business rules and transaction information to the transcoded content information, as described in further detail below.

FIG. 2B is a block diagram of one embodiment of a server within the communication network. As illustrated in FIG. 2B, in one embodiment, server 102 includes a playback server module 203 coupled to the transcoder module 202 within the content provider 104. Server 102 may also include other components, such as, for example, the content servers 240, the transaction servers 250, and the business servers 260. Servers 240, 250, and 260 are different logical entities, but it is to be understood that all servers, including server 102, may reside on a single physical entity.

The playback server module 203 embodies one or more general-purpose computers. The playback server module 203 may also embody a network device such as a network router, switch, bridge, gateway, or other like network device to perform the operations described herein. In one embodiment, the playback server module 203 further includes a control server module 23 coupled to the transcoder module 202 and a streaming server module 214 coupled to the control server module 213. Alternatively, the control server module 213 and the streaming server module 214 may be combined into a single server component to perform operations described herein. In another alternate embodiment, the control server module 213 may reside on a client 103.

As shown in FIG. 2B, in one embodiment, the control server module 213 further includes one or more components, such as, for example, an optimization component 221 to receive and decrypt transcoded content information from the transcoder module 202 and to format the transcoded content information for further processing within the playback server module 203. In an alternate embodiment, if the transcoded content information is not encrypted, the optimization component 221 receives and formats the transcoded content information for further processing.

In one embodiment, the control server module 213 further includes a rules enforcement component 222 coupled to the optimization component 221 and to one or more of the content servers 240, transaction servers 250, and business servers 260 to receive and to execute applicable transaction and business rules from the respective servers, and a client control component 223 to interact with client 103 and to control playback of the content for the end user.

FIG. 2C is a block diagram of one embodiment of a transcoding process. As illustrated in FIG. 2C, in one embodiment, DVD content information 204 includes, for example, audio content 270, video content 271, layout information 272, pan/scan vectors 273, subpicture overlays (buttons) 274, event model/scripting information 275, text 276, graphics 277, MPEG-2 stills 278, and animation/video loops 279. Alternatively, the DVD content information 204 may include other standard components. In one embodiment, the DVD content information 204 is subsequently transcoded at functional block 205 to obtain packages 280 through 284 containing transcoded DVD components, such as, for example, video 280, audio 281, application 282 in XML format, and other XML data 283. The XML application 282 contains the presentation information and asset metadata components, such as the layout information 272, pan/scan vectors 273, buttons 274, scripting information 275, graphics 277, MPEG-2 stills 278, and animation 279. The XML data 283 includes the text 276. Finally, the video and audio packages 280, 281 include the respective video content 271 and audio content 270.

In one embodiment, as shown in FIG. 2C, optional third party products 290, such as, for example, business rules and transaction information, are further applied to each package 280 through 284 in order to reformat the content information extracted from the content source 201. Finally, the information is distributed to the control server information at functional block 206.

FIG. 3 is a block diagram of one embodiment of a client within the communication network. As illustrated in FIG. 3, in one embodiment, client 103 includes a playback client module 310 to receive content and additional information from server 102 and to act as an interface between an end user and the server 102, a set-top box device 320 coupled to the playback client module 310, and a display device 330, such as, for example, a television set, coupled to the set-top box device 320. In an alternate embodiment, client 103 may include a Personal Video Recorder (PVR) (not shown) to store the content information prior to display on the display device 330, and/or a game console. In another alternate embodiment, the playback client module 310 may reside within the display device 330.

The playback client module 310 is a programmable software and/or hardware module to perform operations as described herein. In one embodiment, the playback client mode 310 receives information from server 102 in a broadcast mode. Alternatively, the playback client module 310 may receive the information in an on-demand mode over a two-way network or, in yet another alternate embodiment, in a hybrid mode.

In one embodiment, the processing module 210 within the transcoder module 202 receives one or more transcoding rules from content servers 240, such as, for example, “transcode MPEG-2 video assets such that the bandwidth requirement is reduced from 4.7 Mbps to 3.6 Mbps”. In addition, the processing module 210 receives one or more business rules from business servers 260, such as, for example, “the price of an asset element is $1.95”. Furthermore, the processing module 210 receives transaction information from transaction servers 250, such as, for example, the link that will enable the customer to buy the content source or DVD 201 from the television set 330.

In one embodiment, the decryption module 211 within the transcoder module 202 reads content information from the content source 201, such as, for example, DVD content information, and decrypts the content information using one of many known decryption techniques. The decryption module 211 further passes the decrypted content information to the processing module 210 within the transcoder module 202. Alternatively, the processing module 210 receives already decrypted content information directly from the content source 201 or from a separate device (not shown) that performs the decryption operation.

The content information read from the content source 201 includes the rich media assets, such as video content and/or audio content, and other associated data, such as, for example, presentation information, asset metadata, and text. The processing module 210. transcodes the content information based on rules supplied by the respective servers 240-260. The transformations ensure that the content information can be transported using an appropriate-bandwidth over network 101 to respective modules within the client 103, and further ensures that the content can be played back on a variety of devices for the end user.

In one embodiment, the processing module 210 transcodes the rich media assets (e.g., audio/video content) according to the transcoding rules received from the content servers 240. For example, the processing module 210 transcodes a 6 Mbps MPEG-2 video content to a 3.6 Mbps MPEG-2 video or, alternatively, to an MPEG-1 video.

In addition, the processing module 210 transcodes the data associated with the audio/video content, such as, for example, presentation information, text, and asset metadata, based on applicable transcoding rules. For example, interactive menus based on a 720×480 resolution may be transcoded into a 640×480 resolution. Furthermore, subpicture overlays such as, for example, buttons, which are limited to four allowed colors, may be transcoded into a 16-bit color universe based on the received transcoding rules. Similarly, interactivity/navigation data and commands are also transcoded into the same or a similar predetermined format in order to be used within the system.

In one embodiment, asset metadata within the DVD content information, such as, for example, parental control levels, regional codings, and/or pan/scan vectors, is also transcoded by the processing module 210 into a predetermined format, such as, for example, the XML format, in order to be packaged for transmission to the playback server module 203 and further to respective modules within clients 103. Furthermore, the text component within the DVD content information is transcoded into the XML format.

Additional business rules received from the business servers 260 in the predetermined format are appended to the transcoded content information and further forwarded to the playback server module 203. Transaction information received from the transaction servers 250 in the predetermined format is also appended to the transcoded content information and forwarded to the playback server module 203.

In one embodiment, the encryption module 212 within the transcoder module 202 receives the transcoded rich media assets, the transcoded associated data, and the supplemental data, such as, for example, the business rules and the transaction information, from the processing module 210 and encrypts the information using one of many known encryption techniques. The encryption module 212 further passes the encrypted information to the playback server module 203. Alternatively, the processing module 210 transmits the unencrypted transcoded content information and rules directly to the playback server module 203.

In one embodiment, the streaming server module 214 within the playback server module 203 receives and stores the transcoded rich media assets. The optimization component 221 within the control server module 213 receives the transcoded associated data from the transcoder module 202 and decrypts the information according to one of many known decryption techniques. Alternatively, if the transcoded associated data is received directly from the processing module 210, no decryption is required. Similarly, the optimization component 221 decrypts the business rules and the transaction information received from the transcoder module 202. The optimization component 221 further formats the transcoded associated data for delivery to specific clients 103 according to specification requirements for each client 103.

In one embodiment, the rules enforcement component 222 within the control server module 213 receives additional supplemental data, for example, business rules and transaction information, from the respective servers 250 and 260 and executes the rules applicable to the transcoded associated data and to the specific transaction. Subsequently, an application containing the transcoded associated data formatted for the specific client 103, which includes the transcoded presentation information, transcoded asset metadata, and other information related to the rich media assets, is transmitted to the client 103 via the client control component 223. Alternatively, the application is transmitted to the client 103 upon receipt of an application request from the client 103.

In one embodiment, the playback client module 310 receives the application in a broadcast mode. Alternatively, the playback client module 310 may receive the application in an on-demand mode over a two-way network, or in a hybrid mode.

Once the playback client module 310 runs the application and the end user is presented with the interactive menus on the display device 330, the user communicates with the playback client module 310 via the set-top box device 320 through stream control commands and/or requests. For example, the user prompts the playback client module 310 to communicate a transaction request to the client control component 223 within the control server module 213, in which streaming rich media assets, such as audio/video content, may be requested. In one embodiment, the interactive menus displayed for the user on the display device 330 include DVD specific menu items, such as, for example, Title, Menu, Angle, which are mapped to buttons on a remote control (not shown) and/or soft interface buttons accessible to the end user via the display device 330. In addition, the interactive menus may include other stream control commands such as, for example, Play, Pause, Fast Forward, Rewind, Alternate Camera Angle, Change Audio Track, Skip, which enable the end user to communicate such commands to the playback server module 203 via the playback client module 310.

In one embodiment, the playback client module 310 transmits the transaction request to the client control component 223 within the control server module 213. The client control component 223 receives the transaction request and prompts the rules enforcement component 22 to execute applicable business rules received from the business servers 260. Furthermore, the rules enforcement component 222 executes applicable transaction information received from the transaction servers 250 and related to the transaction request received from the playback client module 310.

Subsequent to the execution of the business rules and the transaction information, the client control component 223 communicates with the. streaming server module 214 and instructs the streaming server module 214 to interactively transmit stored rich media assets (e.g., video and/or audio content) to the client 103 based on the stream control commands received from the end user via the playback client module 310. In one embodiment, the streaming server module 214 is responsible for the playback of the video and/or audio content based on various playback control data, such as, for example, parental control rating levels, audio track selected, audio type selected, subtitle language selected, camera angle selected, and other indicators which may be selected by the end user using the interactive menus displayed on the display device 330. The streaming server module 214 receives and responds to the stream control commands transmitted by the end user via the client control component 223 and tailors the playback of the video and/or audio content to the stream control commands. For example, if the end user enters a PG-13 parental control rating level, the streaming server module 214 transmits only the video and audio frames that meet the requested parental rating level.

In an alternate embodiment, if no additional business rules and/or transaction information need to be executed, the playback client module 310 may transmit a playback request directly to the streaming server module 214. Responsive to the playback request, the streaming server module 214 may interactively transmit the requested rich media assets to the client 103 based on the stream control commands received from the end user via the playback client module 310.

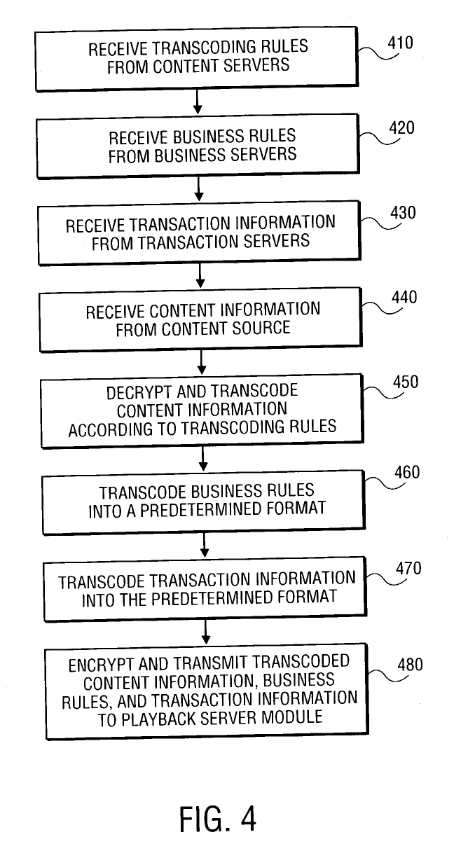

FIG. 4 is a flow diagram of one embodiment of a method to transcode content information within the content provider 104. As illustrated in FIG. 4, at processing block 410, transcoding rules are received from content servers 240. In one embodiment, the processing module 210 within the transcoder module 202 receives the transcoding rules.

At processing block 420, business rules are received from business servers 260. In one embodiment, the processing module 210 receives the business rules from the business servers 260.

At processing block 430, transaction information is received from transaction servers 250. In one embodiment, the processing module 210 receives the transaction information.

At processing block 440, content information is received from content source 201. In one embodiment, the decryption module 211 receives the content information, which includes, for example, rich media assets, associated data, and other content information that may be stored on the content source 201. Alternatively, the processing module 210 receives the content information directly from the content source 201 or from a separate device that performs decryption operations.

At processing block 450, the content information is decrypted and transcoded according to the received transcoding rules. In one embodiment, the decryption module 211 decrypts the content information and passes the decrypted content information to the processing module 210 for transcoding according to the transcoding rules. Alternatively, if the decryption operation is not required, the processing module 210 transcodes the content information according to the transcoding rules, as described in detail above.

At processing block 460, business rules and transaction information are added to the transcoded content information. In one embodiment, the processing module 210 appends the business rules received from the business servers 260 and the transaction information received from the transaction servers 250 to the transcoded content information for subsequent transmission to the playback server module 203.

At processing block 470, the transcoded content information, and appended business rules, and transaction information are encrypted and transmitted to the playback server module 203. In one embodiment, the encryption module 212 encrypts the transcoded content information, business rules, and transaction information using one of many known encryption techniques, and transmits the encrypted information to the playback server module 203. Alternatively, if encryption is optional, the processing module 210 may transmit the transcoded content information, business rules, and transaction information directly to the playback server module 203.

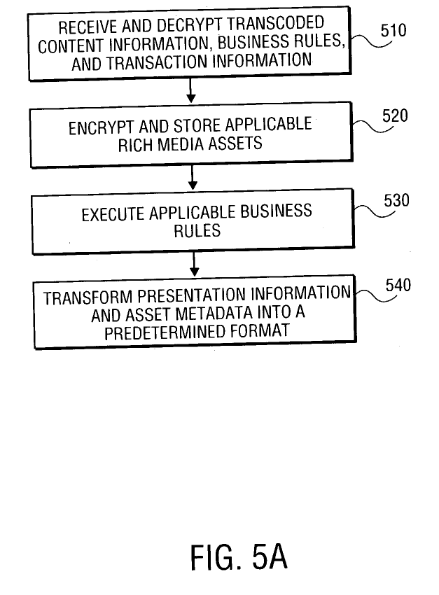

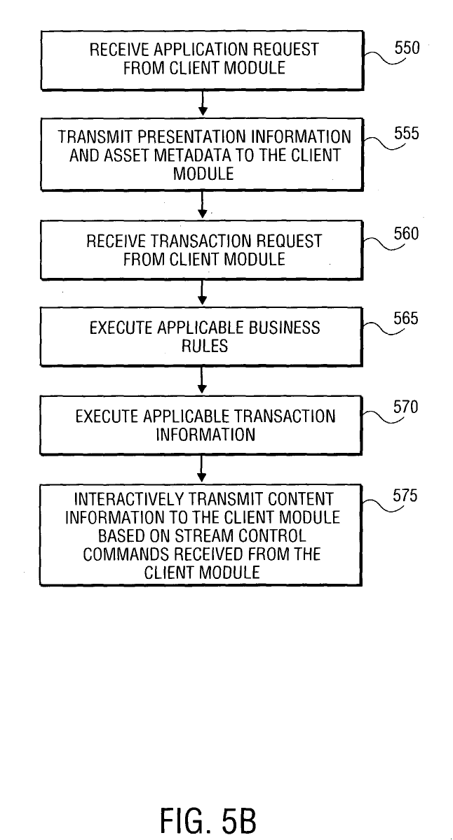

FIG. 5A is a flow diagram of one embodiment of a method to receive and process the transcoded content information within the server for transmission to one or more clients. As illustrated in FIG. 5A, in one embodiment, at processing block 510, transcoded content information, business rules, and transaction information are received from the transcoder module 202 and are decrypted. In one embodiment, the optimization component 221 within the control server module 213 receives and decrypts the transcoded content information, the business rules, and the transaction information. Alternatively, the optimization component 221 receives the transcoded content information, business rules, and transaction information directly from the processing module 210 and no decryption is performed.

At processing block 520, applicable rich media assets within the transcoded content information are stored. In one embodiment, the optimization component 221 retrieves the rich media assets from the transcoded content information and stores the rich media assets in the streaming server module 214.

At processing block 530, additional applicable business rules and transaction information are executed. In one embodiment, the rules enforcement component 222 within the control server module 213 receives the additional business rules and transaction information in a predetermined format, such as, for example, the XML format, and executes the business rules and transaction information applicable to this phase of the process.

At processing block 540, transcoded presentation information and asset metadata are formatted for transmission to a specific client 103. In one embodiment, the control server module 213 formats an application containing the transcoded presentation information and asset metadata received from the transcoder module 202 for subsequent transmission to the client 103.

FIG. 5B is a flow diagram of one embodiment of a method to transmit video and/or audio content to clients within the communication network. As illustrated in FIG. 5B, at processing block 550, formatted and transcoded presentation information and asset metadata are transmitted to the playback client module 310. In one embodiment, the control server module 213 transmits the application containing the formatted and transcoded presentation information and asset metadata to the playback client module 310.

At processing block 560, a decision is made whether any additional rules and/or transaction information are required for playback. If additional rules and/or transaction information need to be executed in order to playback the rich media assets stored in the streaming server module 214, at processing block 565, a transaction request is received in the client control component 223.

At processing block 570, applicable business rules are executed. In one embodiment, based on the transaction request, the rules enforcement component 222 executes business rules associated with the client 103 and the respective transaction. At processing block 575, applicable transaction information is executed. In one embodiment, the rules enforcement component 222 executes the transaction information associated with the transaction requested by the client 103.

Finally, at processing block 580, rich media assets are interactively transmitted to the client 103 based on stream control commands received from the end user. In one embodiment, the streaming server module 214 within the server 102 transmits rich media assets to the client 103 based on various playback control data and stream control commands received from the end user via the client 103.

Otherwise, if no additional rules and/or transaction information need to be executed, at processing block 585, a playback request is received in the streaming server module 214. Next, the process jumps to processing block 580, where rich media assets are interactively transmitted to the client 103 based on stream control commands received from the end user.

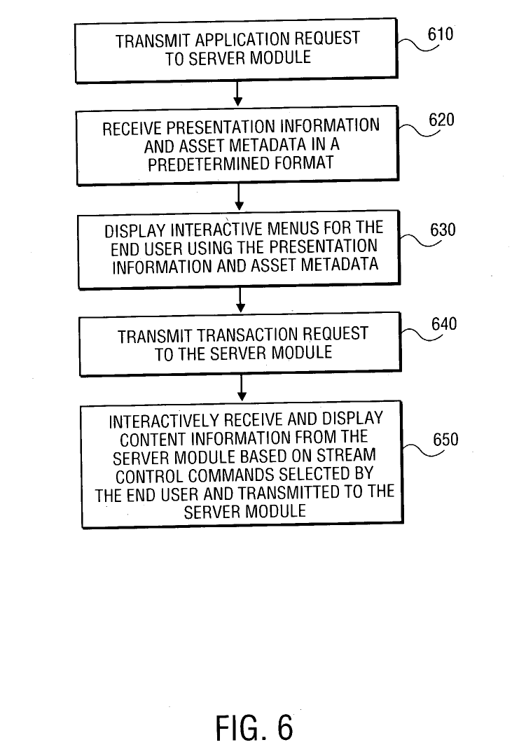

FIG. 6 is a flow diagram of one embodiment of a method to receive and display the video and/or audio content for an end user. As illustrated in FIG. 6, at processing block 610, formatted and transcoded presentation information and asset metadata are received in a predetermined format. In one embodiment, the playback client module 310 receives the application containing the formatted and transcoded presentation information and asset metadata in a predetermined recognizable format such as, for example, the XML format.

At processing block 620, interactive menus are displayed for the end user using the presentation information and the asset metadata. In one embodiment, the playback client module 310 displays one or more interactive menus on the display device 330 using the transcoded presentation information and the transcoded asset metadata. The interactive menus allow the end user to communicate user actions to the client control component 223 within the control server module 213 via playback client module 310.

At processing block 630, a decision is made whether any additional rules and/or transaction information are required for playback of the rich media assets. If additional rules and/or transaction information need to be executed in order to playback the rich media assets stored in the streaming server module 214, at processing block 640, a transaction request is transmitted to the client control component 223. In one embodiment, the playback client module 310 receives a user command to initiate a transaction with the server 102 and transmits a transaction request to the client control component 223. At processing block 650, rich media assets are interactively received from the streaming server module 214 and displayed for the end user based on stream control commands selected by the end user and transmitted to the server 102.

Otherwise, if no additional rules and/or transaction information need to be executed, at processing block 660, a playback request is transmitted to the streaming server module 214. Next, the processjumps to processing block 650, where rich media assets are interactively received from the streaming server module 214 based on stream control commands selected by the end user.

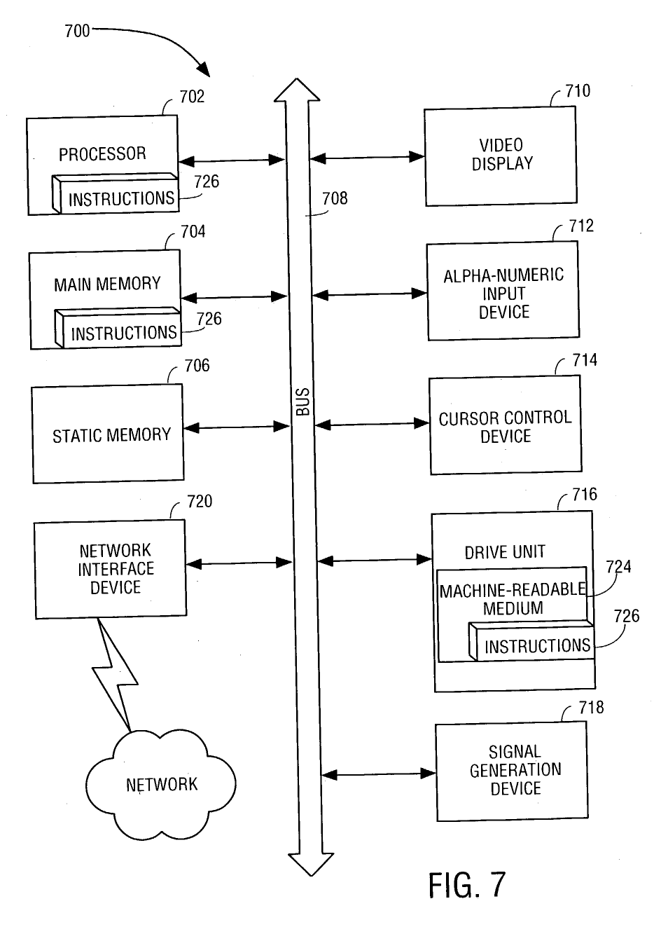

FIG. 7 is a block diagram of one embodiment of a machine in the exemplary form of a computer system 700 within which a set of instructions, for causing the machine to perform any one of the methodologies discussed above, may be executed. In alternative embodiments, the machine may comprise a network router, a network switch, a network bridge, Personal Digital Assistant (PDA), a cellular telephone, a web appliance, a set-top box device, a Personal Video Recorder (PVR), a game console, or any machine capable of executing a sequence of instructions that specify actions to be taken by that machine.

The computer system 700 includes a processor 702, a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard), a cursor control device 714 (e.g., a mouse), a disk drive unit 716, a signal generation device 718 (e.g., a speaker), and a network interface device 720.

The disk drive unit 716 includes a machine-readable medium 724 on which is stored a set of instructions (i.e., software) 726 embodying any one, or all, of the methodologies described above. The software 326 is also shown to reside, completely or at least partially, within the main memory 704 and/or within the processor 702. The software 726 may further be transmitted or received via the network interface device 720.

It is to be understood that embodiments of this invention may be used as or to support software programs executed upon some form of processing core (such as the CPU of a computer) or otherwise implemented or realized upon or within a machine or computer readable medium. A machine readable medium includes any mechanism for storing or transmitting information in a form readable by a machine (e.g., a computer). For example, a machine readable medium includes read-only memory (ROM); random access memory (RAM); magnetic disk storage media; optical storage media; flash memory devices; electrical, optical, acoustical or other form of propagated signals (e.g., carrier waves, infrared signals, digital signals, etc.); or any other type of media suitable for storing or transmitting information.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

What is claimed is:

1. A method, comprising:
transmitting, for playing through a client device that is not equipped with a DVD decoder, content derived from a DVD source,
wherein the content includes rich media assets and associated data, each in a transcoded format other than as originally provided from the DVD source.

2. The method of claim 1, wherein the associated data comprises presentation information and metadata concerning the rich media assets.

3. The method of claim 2, wherein the transcoded format comprises an extensible markup language format.

4. The method of claim 1, wherein the transcoded format is selected according to transcoding rules describing available bandwidth for transmitting the content to the client device.

5. The method of claim 1, wherein the transcoded format is selected according to transcoding rules describing an available decoder at the client device.

6. The method of claim 1, wherein the transcoded format is selected according to transcoding rules and business rules.

7. The method of claim 6, wherein the transcoding rules comprise one or more rules describing available bandwidth for transmitting the content to the client device and rules describing an available decoder at the client device.

8. The method of claim 6, wherein the transcoded format is further selected according to transaction information.

9. The method of claim 1, wherein business rules and/or transaction information are/is appended to the content prior to transmission.

10. The method of claim 1, wherein the associated data includes an application program to be executed by the client device.

11. The method of claim 10, wherein the application program, when executed by the client device, provides an environment for controlling playback of the rich media assets.

12. The method of claim 11, wherein the environment for controlling playback includes one or more interactive menus.

13. A method, comprising developing, from DVD content other than rich media assets, an application program for execution by a device not equipped with a DVD decoder, which application program, when executed by the device, provides one or more interactive menus for controlling playback of a transcoded version of the rich media assets via the device.

14. The method of claim 13, wherein the application program is developed using transcoded presentation information and metadata concerning the rich media assets.

15. The method of claim 14, wherein the presentation information is transcoded, according to transcoding rules, from a DVD source format to an extensible markup language format.

16. The method of claim 15, wherein the presentation information is further transcoded according to one or more business rules and/or transaction information.

17. The method of claim 16, wherein one or more business rules and/or transaction information are/is appended to the presentation information after transcoding.

18. The method of claim 13, further comprising transmitting the application program and presentation information and metadata to the device.

19. The method of claim 18, wherein the application program is transmitted to the device as part of a broadcast over a network.

20. The method of claim 18, wherein the application program is transmitted to the device in response to a request from the device.

21. A computer-readable medium having stored thereon computer-readable instructions, which instructions, when executed by a computer system, cause the computer system to perform a method, comprising developing, from DVD content, transcoded DVD components including transcoded rich media assets and an application program for execution by a device not equipped with a DVD decoder, which application program, when executed by the device, provides one or more interactive menus for controlling playback of the transcoded rich media assets via the device.

22. The computer-readable medium of claim 21, wherein the application program comprises presentation information and rich media asset metadata components.

23. The computer-readable medium of claim 22, wherein the rich media asset metadata components comprise one or more of layout information, pan/scan vectors, buttons, scripting information, graphics, MPEG stills, and/or animations.

24. The computer-readable medium of claim 22, wherein the presentation information is transcoded, according to transcoding rules, from a DVD source format to an extensible markup language format.

25. The computer-readable medium of claim 24, wherein the presentation information is further transcoded according to one or more business rules and/or transaction information.

26. The computer-readable medium of claim 22, wherein the application program comprises a package in extensible markup language format.

27. The computer-readable medium of claim 26, wherein the rich media asset metadata components comprise extensible markup language representations of parental control levels, regional codings, and/or pan/scan vectors.

28. The computer-readable medium of claim 21, wherein the transcoded DVD components further include data in extensible markup language format.

29. The computer-readable medium of claim 28, wherein the data includes text.

30. A system, comprising:
a content source configured to provide content information in a source format, the content information including rich media assets and associated data; and
a transcoder coupled to receive the content information in the source format from the content source and configured to perform transcoding operations to transform the content information from the source format to another format according to transcoding rules,
wherein one output of the transcoding operations comprises an application program, which when executed, provides one or more interactive menus for controlling playback of transcoded rich media assets in the other format.

31. The system of claim 30, wherein the other format comprises an extensible markup language format.

32. The system of claim 30, wherein the application program comprises presentation information and rich media asset metadata components.

33. The system of claim 32, wherein the rich media asset metadata components comprise one or more of layout information, pan/scan vectors, buttons, scripting information, graphics, MPEG stills, and/or animations.

34. The system of claim 30, wherein the transcoding rules include business rules and transaction information.

35. The system of claim 34 wherein the transcoding rules include information regarding a client to execute the application program.

36. The system of claim 30 wherein the transcoder is configured to decrypt the content information prior to transcoding the content information according to the transcoding rules.

37. The system of claim 30 wherein the transcoder is coupled to one or more servers configured to provide the transcoding rules.

38. The system of claim 30 wherein the transcoder is coupled to a playback server configured to broadcast the application program.

39. The system of claim 30 wherein the transcoder is further configured to perform the transcoding operations in response to a request from a client device through which transcoded versions of the rich media assets will be played out.

40. The system of claim 39 wherein the transcoder is coupled to a playback server configured to transmit the transcoded versions of the rich media assets to the client device.
